(19) United States
(12) Patent Application Publication
(10) Pub. No.: US 2017/0262870 A1
(43) Pub. Date: Sep. 14, 2017

(54) INFORMATION PROCESSING APPARATUS, METHOD OF CONTROLLING SAME, AND NON-TRANSITORY COMPUTER-READABLE STORAGE MEDIUM

(71) Applicant: CANON KABUSHIKI KAISHA, Tokyo (JP)

(72) Inventor: Tomohiro SATO, Hino-shi (JP)

(21) Appl. No.: 15/448,994

(22) Filed: Mar. 3, 2017

(30) Foreign Application Priority Data
Mar. 8, 2016 (JP) 2016-044762

(51) Int. Cl. G06Q 30/02; G06Q 20/20; G06K 9/00

(52) U.S. Cl. CPC G06Q 30/0201; G06K 9/00288; G06K 9/00718; G06K 9/00255; G06Q 20/202; G06Q 20/204; G06F 3/0482

(57) ABSTRACT

An information processing apparatus, that processes purchase information according to sales of a product, causes a first display unit to display a selection screen that includes an image, captured by an image capturing apparatus, of at least one person which is displayed on a plurality of display units including the first display unit, and, when a person image is selected in the selection screen, associates information for a person of the selected person image and purchase information of a processing target in the information processing apparatus, and causes a storage unit to store a result of the association. The information processing apparatus causes the first display unit to display the selection screen in accordance with a state of selection of a person image in another information processing apparatus corresponding to a display unit other than the first display unit.

### BACKGROUND OF THE INVENTION

Field of the Invention

The present invention relates to a technique for analyzing video image data, and in particular is a technique relating to identification of people captured in a video image that is captured by a camera or the like.

Description of the Related Art

In recent years, a system in which a person positioned at a cash register is captured using network cameras (hereinafter referred to as cameras), person information is extracted from the captured image, and the person information and purchase information of the person are associated has been proposed (Japanese Patent Laid-Open No. 2013-045132 for example). In such a system, firstly, a camera mounted to a POS (Point of Sales) register or a camera installed near a POS register captures the face of a person who is a customer at a time of payment processing. Customer data (person information) such as the age and the gender of the person is obtained from a captured image by image processing or the like, it is associated with sales data such as an amount of money or purchase points obtained by the POS register, and is stored in a database. Customer data and sales data accumulated in a fixed interval is advantageous information considering business improvement plans in which a manager attempts to improve customer satisfaction, sales, and profits for example.

A conventional customer capturing method in Japanese Patent Laid-Open No. 2013-045132 is described using FIG. 1. FIG. 1 is a view for describing a conventional customer capturing method. Conventionally as in FIG. 1A, various POS registers 111, 112, and 113 are present for lines 101, 102, and 103 of customers who wait in line in order to pay. Also, individual cameras 121, 122, and 123 are respectively installed for the POS registers 111, 112, and 113. Images captured by the cameras 121, 122, and 123 are made to be of a sufficient size necessary for an image analysis so it becomes possible to acquire appropriate person information as in image 131 of FIG. 1B. However, in the configuration of FIG. 1A, a camera is necessary for each of the customer lines. Accordingly, the number of installed POS registers increases in accordance with an increase in customer lines, and there is the possibility that operation costs and installation costs will rise.

To resolve such a problem, a capturing method as illustrated in FIG. 2 can be considered. FIG. 2 is a view for describing a capturing method derived from the conventional method illustrated in FIG. 1. In this capturing method, as in FIG. 2A, various POS registers 211, 212, and 213 are present for lines 201, 202, and 203 of customers who wait in order to pay. Also, a single camera 221 is installed for the POS registers 211, 212, and 213. Because the camera 221 is far from the POS registers 211, 212, and 213 and singlehandedly captures all of the customers positioned near the POS registers 211, 212, and 213, images captured by the camera 221 are not of a sufficient size necessary for an image analysis, as in image 231 of FIG. 2B, and so it becomes difficult to acquire appropriate person information. Although it becomes possible to capture the face of a customer at a size necessary for a video image analysis in a case when the camera 221 performs a capture at a high resolution, it is not possible to resolve the problem that installation costs rise.

### SUMMARY OF THE INVENTION

The present invention provides a technique for precisely obtaining information of a customer by a small number of cameras in consideration of the above described problem.

According to one aspect of the present invention, there is provided an information processing apparatus that processes purchase information according to sales of a product, the apparatus comprises: a display control unit configured to cause a first display unit to display a selection screen that includes an image, captured by an image capturing apparatus, of at least one person which is displayed on a plurality of display units including the first display unit; and an association unit configured to, when a person image is selected in the selection screen, associate information for a person of the selected person image and purchase information of a processing target in the information processing apparatus, and cause a storage unit to store a result of the association, wherein the display control unit causes the first display unit to display the selection screen in accordance with a state of selection of a person image in another information processing apparatus corresponding to a display unit other than the first display unit.

Further features of the present invention will become apparent from the following description of exemplary embodiments (with reference to the attached drawings).

### BRIEF DESCRIPTION OF THE DRAWINGS

FIGS. 1A and 1B are schematic views for describing conventional customer capturing methods.

FIGS. 2A and 2B are schematic views for describing customer capturing methods derived from the conventional methods.

FIG. 3 illustrates an example of hardware configurations of an information processing apparatus 421.

FIG. 4 illustrates one example of a configuration of an information processing system according to a first embodiment.

FIGS. 5A and 5B are schematic views for describing customer behavior and operator operation.

FIG. 6 is a schematic view illustrating transitions of display screens in POS registers.

FIG. 7 is a flowchart for processing of a video image processing apparatus 401.

FIGS. 8A-8C are flowcharts for processing of the information processing apparatus 421.

### DESCRIPTION OF THE EMBODIMENTS

Below, with reference to the attached drawings, a detailed explanation is given for the present invention based on embodiments. Note that configurations illustrated in the following embodiments are merely examples, and the present invention is not limited to the illustrated configurations.

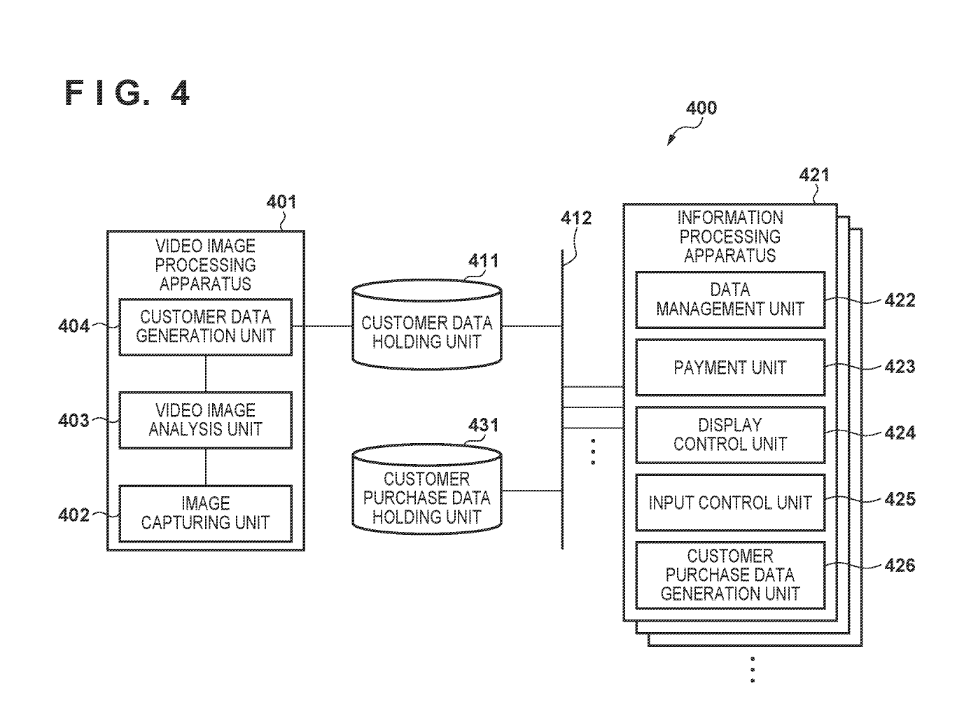

Description is given regarding an information processing system which stores to a database customer data associated with sales data as a first embodiment. FIG. 4 is a view illustrating one example of a configuration of an information processing system 400 in the present embodiment. The information processing system 400 is configured from a video image processing apparatus 401, a customer data holding unit 411, an information processing apparatus 421, and a customer purchase data holding unit 431.

The video image processing apparatus 401 has an image capturing unit 402, a video image analysis unit 403, and a customer data generation unit 404. The image capturing unit 402 is a camera unit, captures a video image, and transmits the video image to the video image analysis unit 403. The video image analysis unit 403 extracts by image processing a face of a person (customer) in the video image received from the image capturing unit 402. Also, the video image analysis unit 403 generates a face image (image data of a person) which includes the face of the person and transmits it to the customer data generation unit 404. The customer data generation unit 404 obtains, by image recognition processing, customer information (information of a person) such as age and gender from the face image received from the video image analysis unit 403. Also, the customer data generation unit 404 generates customer data by associating the obtained customer information with the face image received from the video image analysis unit 403 and stores the customer data to the customer data holding unit 411. Note, the video image processing apparatus 401 may be configured such that the image capturing unit 402 is separated from other configurations as an image capturing apparatus.

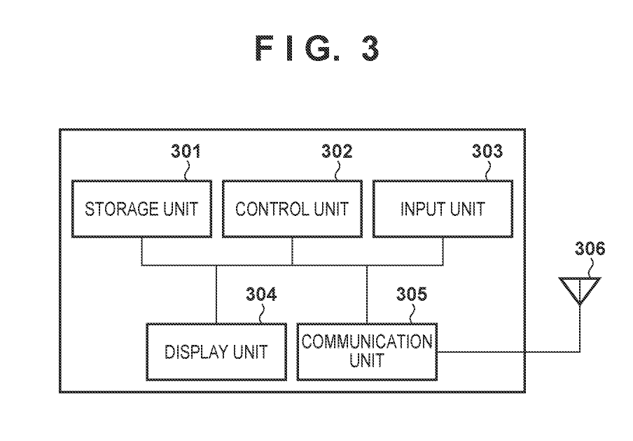

The information processing apparatus 421 is connected to the customer data holding unit 411 and the customer purchase data holding unit 431 via a network 412. The information processing system 400 may have a plurality of the information processing apparatus 421. The information processing apparatus 421 has a data management unit 422, a payment unit 423, a display control unit 424, an input control unit 425, and a customer purchase data generation unit 426. The data management unit 422 performs management of customer data stored in the customer data holding unit 411. The payment unit 423 performs payment processing based on an operation input by an operator and generates sales data (purchase information). The display control unit 424 obtains customer data from the customer data holding unit 411 and presents a face image included in the customer data to the operator via a display unit 304 (refer to FIG. 3). The input control unit 425 performs control corresponding to an input of an operation performed to an input unit 303 (with reference to FIG. 3) in order for the operator to select (designate) one or more face images from among one or more face images presented via the display unit 304. Also, the input control unit 425 temporarily stores customer data corresponding to a face image selected by the operator. The customer purchase data generation unit 426 generates customer purchase data by associating sales data generated by the payment unit 423 with customer data stored by the input control unit 425 and stores the customer purchase data to the customer purchase data holding unit 431.

FIG. 3 is a figure illustrating an example of a hardware configuration of the information processing apparatus 421. A storage unit 301 is configured by a memory such as a ROM (Read Only Memory) or a RAM (Random Access Memory). The storage unit 301 stores a program for performing later described various operations and various information such as communication parameters for wireless communication. Note, apart from a memory such as a ROM and a RAM, a storage medium such as a flexible disk, a hard disk, an optical disc, a magneto-optical disc, a CD-ROM, a CD-R, a magnetic tape, a non-volatile memory card, and a DVD may be used as the storage unit 301. Also, the storage unit 301 may be equipped with a plurality of memories or the like.

A control unit 302 is configured by a processor such as a CPU (Central Processing Unit) or an MPU (Micro Processing Unit). The control unit 302 controls the whole information processing apparatus 421 by executing a program stored in the storage unit 301. Also, configuration may be taken such that the control unit 302 is equipped with a plurality of processors such as a multi-core, and controls the whole information processing apparatus 421 by the plurality of processors.

The input unit 303 accepts various operations from a user. The display unit 304 performs various displays on a screen. Note, configuration may be taken such that both of the input unit 303 and the display unit 304 are realized in a single module such as a touch panel. The display unit 304 is configured by an LCD (Liquid Crystal Display) for example. The display unit 304 outputs information that a user can visually recognize and performs display control of various UIs (User Interface).

A communication unit 305 performs control of wireless communication or wired communication. Also, in a case when wireless communication is performed, the communication unit 305 controls an antenna 306 and performs transmission/reception of a wireless signal for wireless communication. The information processing apparatus 421 transmits content such as video image data to a partner apparatus 102 via the communication unit 305.

<Operator Operations>

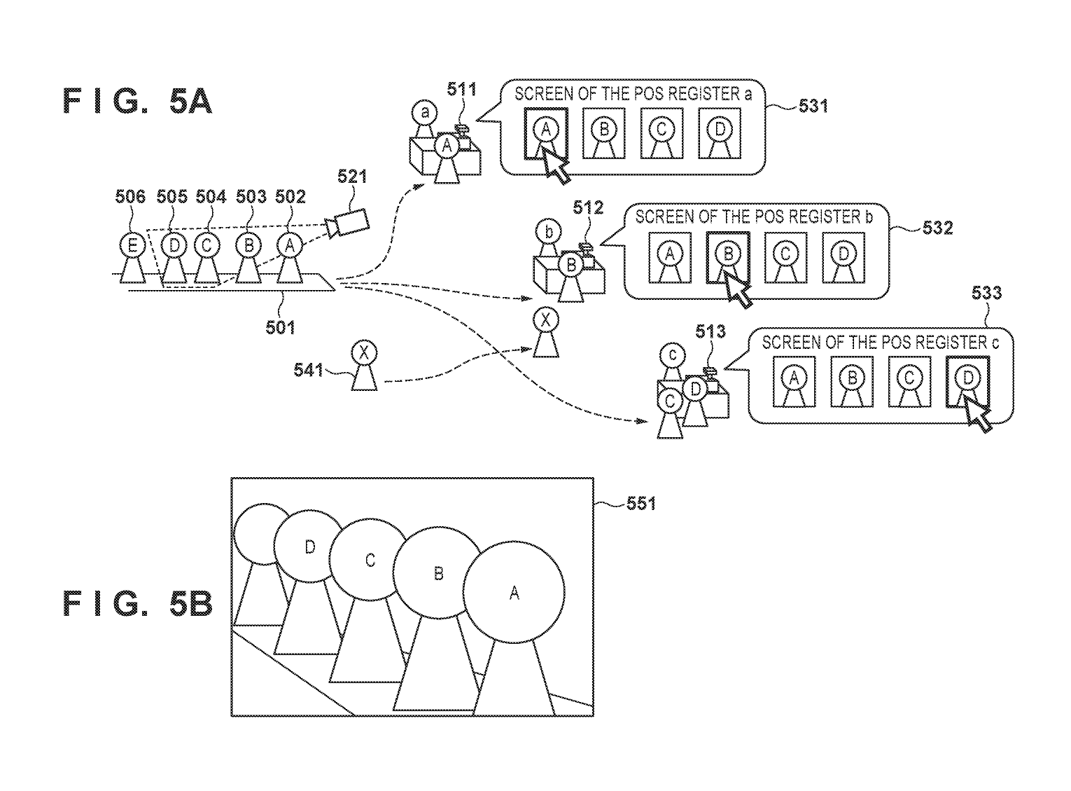

FIG. 5 is views explaining customer behavior and operator operation. In FIG. 5A, operators a, b, and c are capable of operating each POS register 511, 512, and 513. The POS registers 511, 512, and 513 respectively have functions of the information processing apparatus 421 described using FIG. 4. Screens 531, 532, and 533 are examples of screens displayed on the respective display units 304 of the POS registers 511, 512, and 513.

In the present embodiment, it is assumed that a customer lines up in a line such as a customer line 501 before the POS registers 511, 512, and 513. The POS registers 511, 512, and 513 generate customer purchase data based on an input of an operation of the operator. For example, in a case when a customer A 502 proceeds to the POS register 511, the operator a selects the customer A on the screen 531 displayed on the display unit 304 of the POS register 511. Also, the operator a performs an input of an operation for payment processing by the POS register 511. The POS register 511, based on these operations by the operator a, obtains customer data and sales data and generates customer purchase data by linking these data items.

<Customer Behavior>

In the example of FIG. 5A, the customer A 502, a customer B 503, a customer C 504, a customer D 505, and a customer E 506 are lined up in order in the customer line 501. When a previous customer finishes payment at one of the POS registers 511, 512, and 513, the next customer proceeds in order to the open POS register. Also, in the customer line 501, in addition to payers who are customers who make a payment in order to pay, customers who are the companion of a payer may also be lined up. In the example of FIG. 5A, the customer D 505 is a payer and the customer C 504 is a companion of the customer D 505. Furthermore, a customer who is not lined up in the customer line 501 may also be present (customer X 541 in the example of FIG. 5A). In the present embodiment, because it is assumed that it is necessary for a customer to line up in the customer line 501 in order to make a payment, it is possible to ignore the presence of the customer X 541 in such a case. Alternatively, even if the customer X 541 is a companion of the customer B 503, the customer X 541 will not make a payment, and so it is possible to ignore the presence of the person similarly in such a case.

<Example of Camera Layout>

In the present embodiment, one camera 521 is installed so that it is possible to capture in order from the start of the customers lined up in the customer line 501. The camera 521 corresponds to the image capturing unit 402 of the video image processing apparatus 401 in FIG. 4. Customer A 502 through customer E 506 line up in the customer line 501 prior to making a payment and customers who make a payment are always captured in the camera 521 because they move to one of the POS registers 511, 512, and 513 in order from the start of the line.

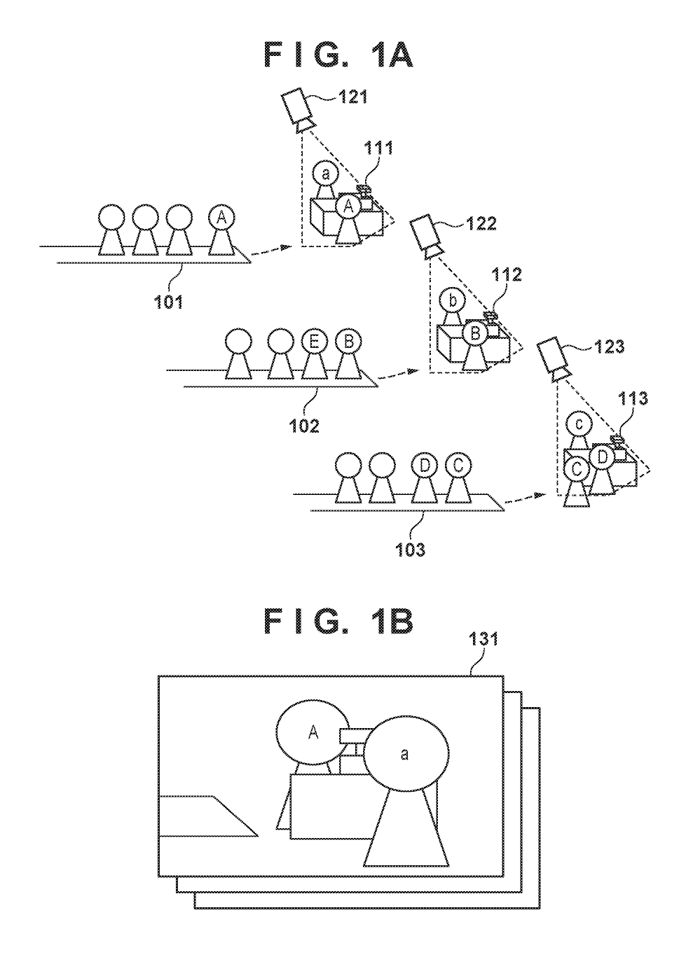

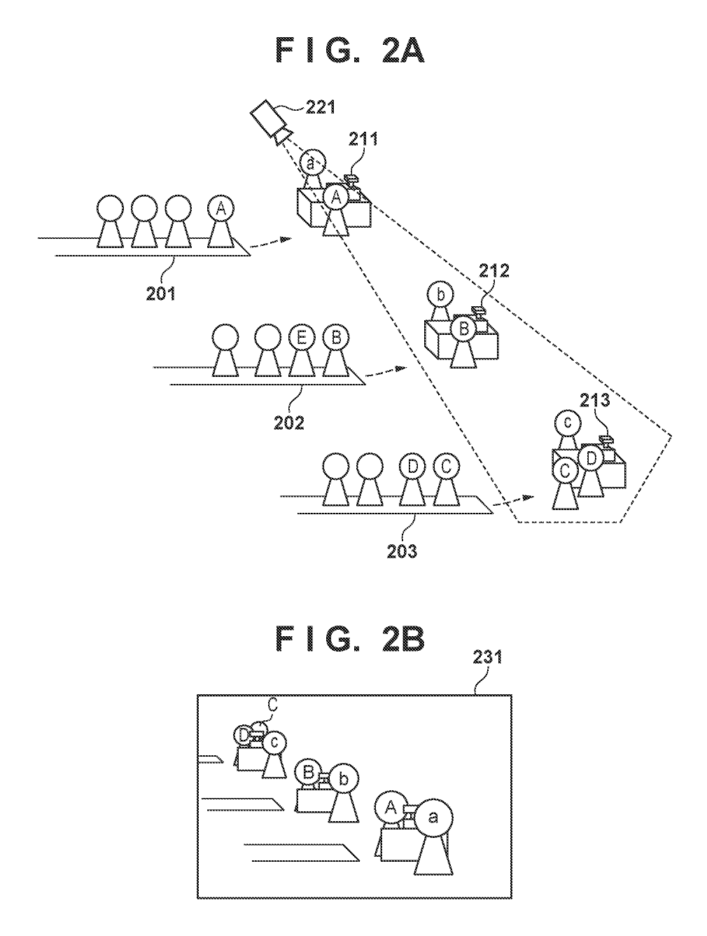

It is not necessary for the camera 521 to capture in one go the customers A 502 through the customer E 506 lined up in the customer line 501, and it is enough if it is possible to capture some people in order from the start of the line at a sufficient size to perform image processing. For example, the camera 521 may perform a capture so that four customers at the start of the line are captured in a single screen as illustrated in a screen 551 of FIG. 5B. By configuring in this way, it is not necessary to mount one camera for each POS register as in FIG. 1, and so it does not result in a size for which image processing is difficult as in FIG. 2.

Note, an installation position of a camera is not limited to the position of the camera 521 as illustrated in FIG. 5A. For example, at least one camera may be set to correspond to 2 or more lines in a case when a plurality of lines such as the customer line 501 exist. Also, it is possible that a camera is installed at an entrance of the store. In a case when a camera is installed at the entrance of the store, configuration may be taken such that images of customers who left the store without buying for a product are deleted from the selection screen.

<POS Registers Display Screens Transitions>

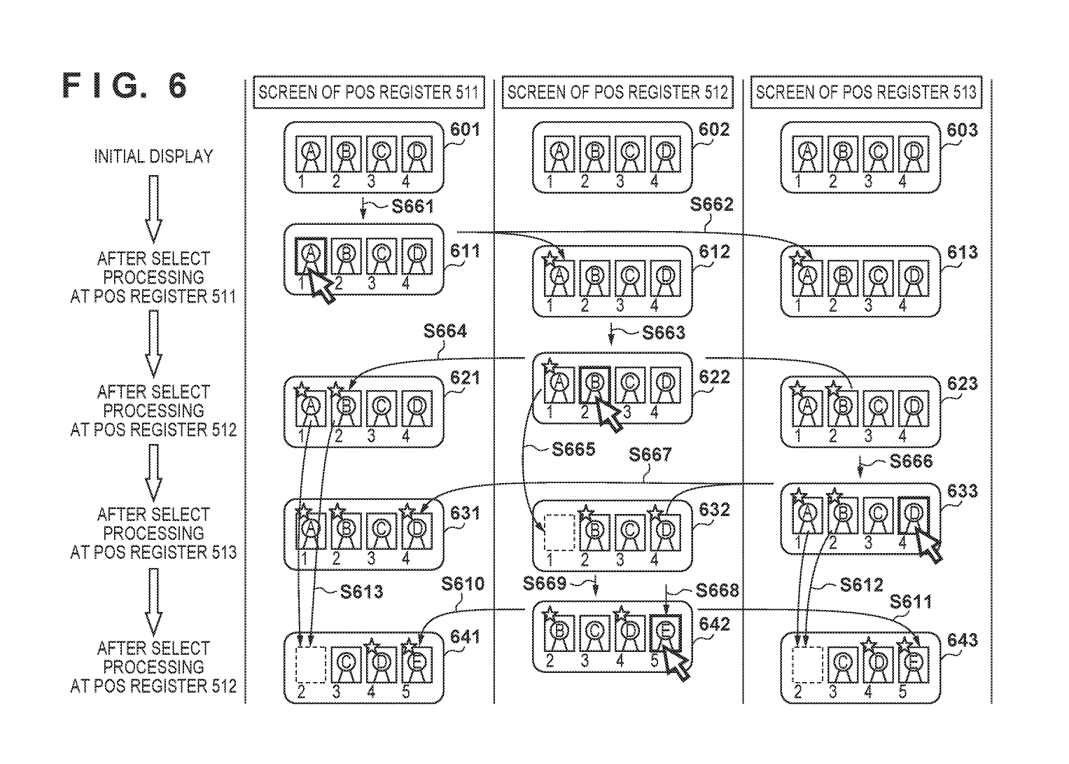

Description is given regarding an example of screens on the display unit 304 of the POS registers 511, 512, and 513 with reference to FIG. 5 and FIG. 6. FIG. 6 illustrates transitioning of screens displayed on the display unit of the POS register. Screens 601, 602, and 603 are respectively initial screens displayed on the display unit 304 of the POS registers 511, 512, and 513. On the screens 601, 602, and 603, four customers (customer A 502 through customer D 505) from the start of the customer line 501 are displayed. Although the numbers illustrated below the customers displayed on each screen are numbers assigned to the customers in order from the start of the customer line 501, configuration may be such that the numbers are not assigned.

Firstly, the operator a selects an image of the customer A displayed on the screen 611 because the customer A who was lined up in the customer line 501 moved to the POS register 511 and paid (step S661). The operation is accepted and display is performed in a state in which an already selected mark (attached star mark in FIG. 6) is added on the image of the customer A in the screen 612 of the POS register 512 and the screen 613 of the POS register 513 (step S662). Specifically, an image of the customer A is identifiably displayed as being already selected. By such a display, it becomes possible to select a customer who will pay at each POS register quickly because the operator b and the operator c clearly know that the customer A is a customer who paid at another cash register. However, considering the possibility that the operator a will select an image of the customer A by mistake, the operators a, b, and c can still select the image of the customer A on the POS registers 511, 512, and 513. Also, an already selected mark is added (screen 621 regarding the customer A for example) to an image of a customer selected by an operator.

Next, the operator b selects an image of the customer B displayed on the screen 622 because the customer B who was lined up in the customer line 501 moved to the POS register 512 and paid (step S663). Similarly to step S662, display is performed in a state in which an already selected mark is added to an image of the customer B in the screen 621 of the POS register 511 and on a screen 623 of the POS register 513 (step S664). Here, because the customer A, who started payment before the customer B who is selected by the operator b, cannot be a customer target who is selected hereafter, an image of the customer A becomes hidden in the screens 632 and 642 following the screen 622 in the POS register 512 (step S665).

Next, the operator c selects an image of the customer D displayed on the screen 633 because the customer C and the customer D who were lined up in the customer line 501 moved to the POS register 513 and the customer D paid (step S666). The operator c is treated as having performed a correct operation because the customer C is a companion of the customer D. Display is performed in a state in which an already selected mark is added to an image of the customer D in a screen 631 of the POS register 511 and in the screen 632 of the POS register 512 (step S667). The already selected mark is not added to the image of the companion customer C because they are not treated as a purchaser. Furthermore, the images of the customer A and the customer B corresponding to the customer A and the customer B who started payment before the customer are hidden in a screen 643 following the screen 633 on the POS register 513.

In the screen 642 of the POS register 512, an update is performed so that an image of the next customer lined up in the customer line 501 is displayed on the screen because the image of the customer A became hidden (step S668). The operator c selects an image of the customer E displayed on the screen 642 because the customer E who was lined up in the customer line 501 moved to the POS register 512 and paid (step S669). Display is performed in a state in which an already selected mark is added to an image of the customer E in a screen 641 of the POS register 511 and in the screen 643 of the POS register 513 (step S610 and step S611). Also, on the screen 643 in the POS register 513, because the customer A and the customer B who started payment before the customer E cannot become the selected customer target, the images of the customer A and the customer B become hidden (step S612).

Also, the possibility that a customer that has been displayed on the screen for a long time paid at another POS register but was not selected by an operator by mistake, or the customer gave up waiting for the register along the way can be considered. For this reason, face images of customers for which a fixed interval has elapsed while being displayed are periodically made to be hidden. In FIG. 6, an example is illustrated in which, in a screen transition from the screen 621 to a screen 641 (step S613), the image of the customer B becomes hidden in the POS register 511 because the customer B is already selected by another POS register and a fixed interval has elapsed. Also, the operator a can delete an image of the customer A by accepting that the customer A finished payment (step S613). Note, in order to improve the operability of an operator of each POS register, configuration may be taken such that processing in another POS register is caused to be reflected (updated) in the selection screen at a timing at which a selection of a customer is performed in each POS register by the operator.

<Flow of Customer Data Generation Processing>

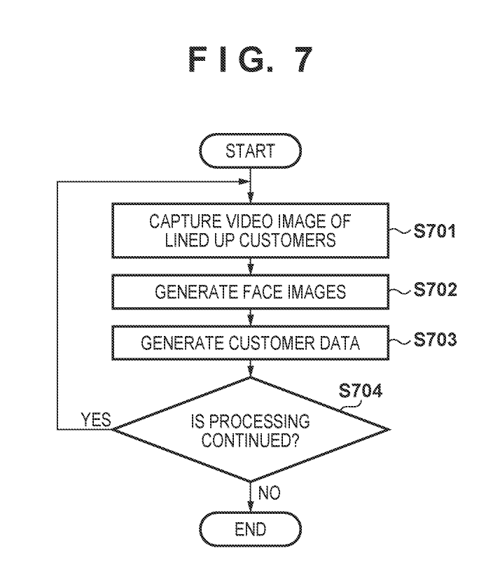

FIG. 7 is a flowchart for processing of the video image processing apparatus 401. The video image processing apparatus 401 captures customers lined up in the customer line 501, generates customer data, and stores the customer data to the customer data holding unit 411.

Firstly, in step S701, the image capturing unit 402 (specifically a camera) captures a video image of customers lined up in a customer line. In step S702, the video image analysis unit 403 recognizes a face of a person captured in the video image captured by the image capturing unit 402 and generates a face image for which only the face is cut out. In step S703, the customer data generation unit 404 performs image recognition on the face image generated in step S702, obtains customer information (such as the age and gender of the customer), and generates customer data by associating customer information and the face image. Here, configuration may be taken such that the customer data generation unit 404 references face images of customer data that is already stored in the customer data holding unit 411 and does not generate customer data for a face image identified as being of the same customer. Also, configuration may be taken such that the customer data generation unit 404 always deletes customer data which includes a face image identified as being of the same customer among customer data already stored in the customer data holding unit 411 prior to generating the customer data, and then stores the new face image. Also, the customer data generation unit 404 may attach numbers in order to the customer data stored in the customer data holding unit 411.

In step S704, if customer data generation processing is continued (Yes in step S704) the processing returns to step S701, and if not (No in step S704) the processing is terminated. For example, configuration may be taken such that the customer data generation processing is continued in a case when capturing of a video image by the image capturing unit 402 is continued or in a case when an input of an instruction by an operator is performed.

<Flow of Processing of Selection Units for Purchaser Candidates>

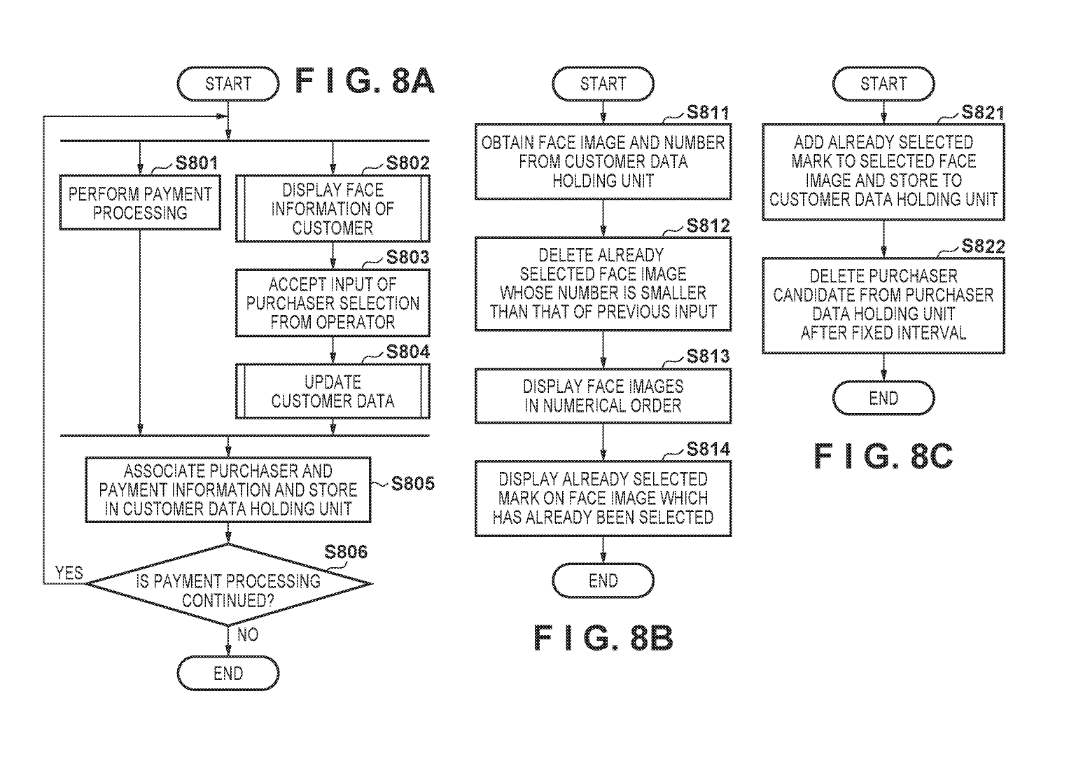

FIG. 8A-8C are flowcharts for processing of the information processing apparatus 421. The information processing apparatus 421, based on an input of an operation of an operator, performs payment processing and selection of a face image of a customer, generates customer purchase data, and stores the customer purchase data in the customer purchase data holding unit 431.

Firstly, description is given for processing of the whole information processing apparatus 421 with reference to FIG. 8A. In step S801, the payment unit 423 performs payment processing and generates sales data based on an input of an operation of an operator. The input of an operation of an operator is performed to the input unit 303 and the input control unit 425 performs an instruction corresponding to the operation input to the payment unit 423. The information processing apparatus 421, in parallel with the payment processing, performs a selection of a customer who is making the payment based on the input of the operation of the operator as described in step S802 to step S804 with reference to FIG. 6. Specifically, in step S802, the display control unit 424 obtains a face image of customer data stored in the customer data holding unit 411 and displays it to the display unit 304. In step S803, the input control unit 425 selects a customer displayed on the display unit 304 by an input of an operation performed to the input unit 303 by the operator. Subsequently, in step S804, the data management unit 422 performs an update of customer data stored in the customer data holding unit 411.

After the processing of step S801 and step S804 completes, the customer purchase data generation unit 426 in step S805 associates sales data generated by the payment unit 423 and customer data corresponding to the face image of the customer selected by the input control unit 425 and generates customer purchase data. After this, if the information processing apparatus 421 continues the payment processing (Yes in step S806), the processing returns to step S801 and step S802. When this is not the case (No in step S806), the processing ends. A case in which the information processing apparatus 421 accepts an input of an operation for continuing the payment processing by the operator is envisioned as a case in which the payment processing continues.

Next, description is given regarding a concrete example of the processing of step S802 with reference to FIG. 8B. In the example of FIG. 8B, it is assumed that numbers are added to customer data stored in the customer data holding unit 411 in the order in which it is stored (an order from the start of the line of customers) and face images included in the customer data and the numbers added to the customer data are associated.

In step S811, the display control unit 424 obtains a face image included in the customer data from the customer data holding unit 411 and a number associated with the face image. In step S812, the display control unit 424 deletes (hides) a face image of a number smaller than the number corresponding to the face image of a customer selected by the input control unit 425 in a case when the processing of step S803 has already been performed. For example, when description is given with reference to FIG. 6, the face image of a customer (customer A) temporally selected prior to the face image of a customer (customer B) that is selected is hidden in the change from the screen 622 to the screen 632 of the POS register 512. In step S813, the display control unit 424 displays to the display unit 304 face images of customers in numerical order. In step S814, the display control unit 424 displays a mark on an already selected face image of a customer that has already been selected by another information processing apparatus 421 and returns to the main routine of FIG. 8A. Note, in the example of FIG. 8B, although the temporal order of the customers is identified by the number associated with the face image of each customer, another identification means may be used if the temporal order of each customer is identified thereby.

Next, description is given regarding a concrete example of the processing of step S804 with reference to FIG. 8C. In step S821, the data management unit 422 adds the already selected mark to the face image of the customer selected in step S803 of FIG. 8A and re-saves it to the customer data holding unit 411. By doing this, the other information processing apparatuses become capable of obtaining customer data in which an existence or absence of a selection is reflected. In step S822, the data management unit 422 deletes from the customer data holding unit 411 customer data corresponding to face information displayed for a fixed interval or more on the display unit 304, and returns to the main routine of FIG. 8A. By this deletion processing, the display control unit 424 does not display the face image included in the deleted customer data on the display unit 304. Note, if it takes five minutes from when a customer lines up in the customer line until the customer finishes payment, for example, the fixed interval is set to about two times that.

In the embodiment described above, description is given in which information of people who line up in a customer line in front of a POS register and perform a payment at the POS register are linked to sales data and this linked data is stored as customer purchase data. However, there are cases in which linkage does not succeed due to a customer leaving the line, a failure of facial recognition, existence of a companion, a work mistake by an operator, or the like. Configuration may be taken such that an operator inputs an error via the input unit 303 in such a case. Also, configuration may be taken such that an operator inputs necessary information (sales data and customer data) via the input unit 303 and linkage is performed in accordance with the input in relation to customer purchase data for which linkage did not succeed. Also, although description is limited to one line of customers in the present embodiment, limitation is not made to there being only one camera. Also, there may be two or more lines of customers because it is not necessary for the number of POS registers and the number of cameras to match.

In this way, by virtue of the present embodiment, it becomes possible to more easily perform processing for precise identification of customers when performing payment processing at a POS register, and linking to customer data such as age and gender by a smaller number of cameras.

### Other Embodiments

Note, in order to improve the operability of an operator of each POS register, configuration may be taken such that processing in another POS register is caused to be reflected (updated) on a selection screen at a timing at which a selection of a customer is performed in each POS register by an operator in the embodiment described above.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-044762, filed Mar. 8, 2016, which is hereby incorporated by reference herein in its entirety.

What is claimed is:

1. An information processing apparatus that processes purchase information according to sales of a product, the apparatus comprising:
a display control unit configured to cause a first display unit to display a selection screen that includes an image, captured by an image capturing apparatus, of at least one person which is displayed on a plurality of display units including the first display unit; and
an association unit configured to, when a person image is selected in the selection screen, associate information for a person of the selected person image and purchase information of a processing target in the information processing apparatus, and cause a storage unit to store a result of the association, wherein
the display control unit causes the first display unit to display the selection screen in accordance with a state of selection of a person image in another information processing apparatus corresponding to a display unit other than the first display unit.

2. The information processing apparatus according to claim 1, wherein the display control unit causes the first display unit to display the selection screen in which it is possible to identify a person image selected in the other information processing apparatus.

3. The information processing apparatus according to claim 1, wherein the display control unit, in accordance with a person image being selected in the other information processing apparatus, causes the first display unit to display the selection screen in which the selected person image is made to be hidden.

4. The information processing apparatus according to claim 1, wherein the display control unit causes the first display unit to display the selection screen in which a person image, for which a fixed interval from when the person image was displayed to the first display unit has elapsed, is made to be hidden.

5. The information processing apparatus according to claim 1, wherein the information for the person is at least one out of an age and a gender of the person of the person image determined based on the person image.

6. The information processing apparatus according to claim 1, wherein the display control unit causes an external display unit of the information processing apparatus to display the selection screen.

7. The information processing apparatus according to claim 1, wherein on the selection screen it is possible to select image data, among image data of people this is displayed on the first display unit, that is not selected by the information processing apparatus corresponding to the other display unit.

8. The information processing apparatus according to claim 1, wherein the selection unit can select the image data of the person displayed on the display unit regardless of whether or not it is selected by the information processing apparatus corresponding to the other display unit.

9. The information processing apparatus according to claim 1, wherein the display control unit deletes, among image data of people displayed on the first display unit, image data of the selected person from the display unit based on an operation of a user.

10. The information processing apparatus according to claim 1, wherein the display control unit deletes from the display unit, among image data of people displayed on the display unit, image data of a person selected by an information processing apparatus corresponding to the other display unit in a case when image data of the person selected by the information processing apparatus corresponding to the other display unit is being displayed on the display unit at a time prior to image data of the person selected by the selection unit.

11. The information processing apparatus according to claim 1, wherein the display control unit deletes from the display unit, among image data of people displayed on the display unit, image data of a person for which a fixed interval has elapsed.

12. A method of controlling an information processing apparatus that processes purchase information according to sales of a product, the method comprising:
causing a first display unit to display a selection screen that includes an image, captured by an image capturing apparatus, of at least one person which is displayed on a plurality of display units including the first display unit;
when a person image is selected in the selection screen, associating information for a person of the selected person image and purchase information of a processing target in the information processing apparatus, and causing a storage unit to store a result of the association; and
causing the first display unit to display the selection screen in accordance with a state of selection of a person image in an information processing apparatus corresponding to another display unit other than the first display unit.

13. A non-transitory computer readable medium storing a computer-executable program for causing a computer to perform a method of controlling an information processing apparatus that processes purchase information according to sales of a product, the method comprising:
causing a first display unit to display a selection screen that includes an image, captured by an image capturing apparatus, of at least one person which is displayed on a plurality of display units including the first display unit;
when a person image is selected in the selection screen, associating information for a person of the selected person image and purchase information of a processing target in the information processing apparatus, and causing a storage unit to store a result of the association; and
causing the first display unit to display the selection screen in accordance with a state of selection of a person image in an information processing apparatus corresponding to another display unit other than the first display unit.
